(19) United States
(12) Patent Application Publication
(10) Pub. No.: US 2024/0047122 A1
(43) Pub. Date: Feb. 8, 2024

(54) COIL WINDING STRUCTURE OF WOUND IRON CORE TRANSFORMER

(71) Applicants: Haihong Electric Co., Ltd., Jiangmen, Guangdong (CN); Guangdong Tritype Electric Co., Ltd., Jiangmen, Guangdong (CN)

(72) Inventors: Kaixuan Xu, Jiangmen, Guangdong (CN); Qingning Liang, Jiangmen, Guangdong (CN); Shuwei Situ, Jiangmen, Guangdong (CN); Yuxiang Qi, Jiangmen, Guangdong (CN); Danju Song, Jiangmen, Guangdong (CN); Wenjie Fang, Jinagmen, Guangdong (CN); Fei Li, Jiangmen, Guangdong (CN); Xueming Zhang, Jiangmen, Gaungdong (CN); Yucheng Zhou, Jiangmen, Guangdong (CN); Wenhui Fang, Jiangmen, Guangdong (CN); Lizhen Zhai, Jiangmen, Guangdong (CN); Dengling Zhou, Jiangmen, Guangdong (CN)

(21) Appl. No.: 17/639,992

(22) PCT Filed: Nov. 10, 2021
(86) PCT No.: PCT/CN2021/129875

§ 371 Date: Mar. 3, 2022

(30) Foreign Application Priority Data
Aug. 23, 2021 (CN) 202121977664.5

(51) Int. Cl. H01F 27/28; H01F 30/12; H01F 30/10; H01F 27/30

(52) U.S. Cl. CPC H01F 27/2847; H01F 30/12; H01F 30/10; H01F 27/30

(57) ABSTRACT

Disclosed is a coil winding structure of a wound iron core transformer applied to a wound iron core transformer. The coil winding structure of the wound iron core transformer includes: an iron core, and a coil. The iron core includes at least one core post; a winding die. The winding die is of a hollow structure, is sleeved around the core post, and includes an upper die, a middle die, and a lower die. One end of the middle die is connected with the upper die and the other end of the middle die is connected with the lower die. The upper die includes a first fixing member and a first rotating member, and the lower die includes a second fixing member and a second rotating member. The first fixing member is connected with the first rotating member, and the second fixing member is connected with the second rotating member. Both the first fixing member and the second fixing member are configured for sleeving the winding die around the core post. Both the first rotating member and the second rotating member are configured for driving the middle die to rotate. The coil is a foil coil, and the coil is wound around the middle die.

### TECHNICAL FIELD

The present disclosure relates to the field of electric power devices, and more particularly, to a coil winding structure of a wound iron core transformer.

### BACKGROUND

With the development of an electric power system, people pay more and more attention to the research and development and use of energy-saving and environment-friendly products. Due to the advantages of three-phase balance, low no-load loss, low no-load current, low noise and low cost, a wound iron core transformer is becoming more and more popular. A foil coil often needs to be used in a wound iron core distribution transformer, and this coil is usually wound horizontally. However, a clamp for clamping an iron core needs to be mounted in this method, so that a winding device is complicated, and an operation is relatively time-consuming. Moreover, for the foil coil, a flatness of a foil is very important. For example, if a copper foil has a scratch or a damaged part, insulation between the foils is easy to be damaged during winding, thus reducing a reliability of the transformer. However, when winding the coil horizontally, it is often difficult to observe a downward face of the copper foil, so that an operator cannot fully control an operation quality. In addition, during winding, since core posts of the iron core are stressed, it is easy to cause a change of no-load loss. Moreover, after finishing winding, the iron core needs to be turned over, and during turning over, the coil is easy to shift to cause coil damage.

### SUMMARY

The present disclosure aims to alleviate at least one of the technical problems in the prior art. In view of this, the present disclosure provides a coil winding structure of a wound iron core transformer, which can simplify a winding device of an iron core, and reduce a probability of change in loss of the iron core caused by winding, thus optimizing a coil winding effect of the wound iron core.

An embodiment of the present disclosure provides a coil winding structure of a wound iron core transformer applied to a wound iron core transformer, the coil winding structure of the wound iron core transformer includes: an iron core, the iron core includes at least one core post; a winding die, the winding die is of a hollow structure, the winding die is sleeved around the core post, and the winding die includes an upper die, a middle die and a lower die, one end of the middle die is connected with the upper die and the other end of the middle die is connected with the lower die, the upper die includes a first fixing member and a first rotating member, the lower die includes a second fixing member and a second rotating member, the first fixing member is connected with the first rotating member, the second fixing member is connected with the second rotating member, the first fixing member and the second fixing member are configured for sleeving the winding die around the core posts, and the first rotating member and the second rotating member are configured for driving the middle die to rotate; and a coil, the coil is a foil coil, and the coil is wound around the middle die.

The coil winding structure of the wound iron core transformer according to some embodiments of the present disclosure has at least the following beneficial effects. In operation, the winding die is sleeved around the core post of the wound iron core, the winding die is fixed to the core post through the first fixing member of the upper die and the second fixing member of the lower die, and the coil is wound around the middle die under rotation of the first rotating member, the second rotating member and the middle die. By means of the coil winding structure of the wound iron core transformer during winding of the coil of the wound iron core transformer, the winding can be performed by simply mounting the winding die, thus avoiding the inconvenience that a winding device in a traditional horizontal winding process needs to be mounted with a clamp of the iron core for clamping the iron core, and simplifying the winding device of the iron core. In addition, since a vertical winding method is used instead of clamping the iron core during winding, an operator can conveniently observe the other face of the copper foil, so as to better control an operation quality. Moreover, this winding method makes the core post unstressed during winding of the coil, so that the no-load loss of the iron core before and after winding is relatively stable, and after finishing winding of the coil, the iron core and the coil do not need to be turned over, thus reducing a probability of change in loss of the iron core caused by winding, and optimizing a winding effect of the coil of the wound iron core.

According to some embodiments of the present disclosure, the iron core is a three-phase stereoscopic wound iron core, and three core posts are provided.

According to some embodiments of the present disclosure, the iron core is a single-phase wound iron core, and two core posts are provided.

According to some embodiments of the present disclosure, the wound iron core transformer includes an upper clamp and a lower clamp, the first fixing member is connected with the upper clamp, and the second fixing member is connected with the lower clamp.

According to some embodiments of the present disclosure, the middle die is of an integrated cylinder structure or is of an assembled cylinder structure formed from a plurality of arc-shaped plates.

According to some embodiments of the present disclosure, each of the first rotating member and the second rotating member is an assembled ring that is formed from at least two arc-shaped plates.

According to some embodiments of the present disclosure, at least one of the upper die and the lower die further includes a transmission wheel, and the transmission wheel is configured for driving each of the middle die, the first rotating member and the second rotating member to rotate.

According to some embodiments of the present disclosure, the coil includes a leading wire, an outlet end of the coil is provided with a copper bar, and one side of the copper bar is provided with a flexible connection.

According to some embodiments of the present disclosure, the outlet end of the coil includes a horizontal portion and a bending portion, and an angle formed between the horizontal portion and the bending portion is 90 degrees.

The additional aspects and advantages of the present disclosure will be given in part in the following description, and will become apparent in part from the following description, or will be learned through the practice of the present disclosure.

### BRIEF DESCRIPTION OF DRAWINGS

The additional aspects and advantages of the present disclosure will become apparent and easily understood from the descriptions of the embodiments with reference to the following drawings, in which:

FIG. 1 is a schematic structural diagram of a coil winding structure of a wound iron core transformer according to an embodiment of the present disclosure;

FIG. 2 is an exploded view of a winding die according to an embodiment of the present disclosure;

FIG. 3 is a schematic structural diagram of a coil winding structure of a wound iron core transformer according to another embodiment of the present disclosure;

FIG. 4 is a schematic structural diagram of an outlet end of a coil according to an embodiment of the present disclosure;

FIG. 5A is a schematic structural diagram of an outlet end of a coil according to another embodiment of the present disclosure;

FIG. 5B is a schematic structural diagram of an outlet end of a coil according to another embodiment of the present disclosure;

FIG. 5C is a schematic structural diagram of an outlet end of a coil according to another embodiment of the present disclosure; and

FIG. 5D is a schematic structural diagram of an outlet end of a coil according to another embodiment of the present disclosure.

### REFERENCE NUMERAL LIST

100 iron core;
200 winding die;
300 coil;
110 core post;
120 upper clamp;
130 lower clamp;
210 upper die;
220 middle die;
230 lower die;
310 copper bar;
320 flexible connection;
330 copper foil;
340 horizontal portion;
350 bending portion;
211 first fixing member;
212 first rotating member;
231 second fixing member; and
232 second rotating member.

### DETAILED DESCRIPTION

The embodiments of the present disclosure are described in detail hereinafter, and the examples of the embodiments are shown in the accompanying drawings, the same or similar reference numerals throughout the accompanying drawings denote the same or similar elements or elements having the same or similar functions. The embodiments described hereinafter with reference to the accompanying drawings are shown by way of example, and are only intended to illustrate the present disclosure, but should not be understood as limiting the present disclosure.

In the description of the present disclosure, “several” refers to being one or more, “multiple” refers to being more than two, and “greater than”, “less than”, “more than”, etc. are understood as not including this number, while “above”, “below”, “within”, etc. are understood as including this number. If there are descriptions of “first” and “second”, it is only for the purpose of distinguishing technical features, and should not be understood as indicating or implying relative importance, implicitly indicating the number of the indicated technical features or implicitly indicating the order of the indicated technical features.

In the description of the present disclosure, it should be understood that the orientation or position relation related to the orientation description, such as the orientation or position relation indicated by “upper”, “lower”, “front”, “rear”, “left”, “right”, etc., is based on the orientation or position relation shown in the accompanying drawings, which is only used for convenience of description of the present disclosure and simplification of description instead of indicating or implying that the indicated device or element must have a specific orientation, and be understood and operated in a specific orientation, and thus should not be understood as a limitation to the present disclosure.

In the description of the present disclosure, if there are descriptions of “first” and “second”, it is only for the purpose of distinguishing technical features, and should not be understood as indicating or implying relative importance, implicitly indicating the number of the indicated technical features or implicitly indicating the order of the indicated technical features.

In the description of the present disclosure, unless otherwise clearly defined, the terms “setting”, “mounting”, “connecting”, etc. should be understood broadly, and those skilled in the art can reasonably determine the specific meanings of the above terms in the present disclosure in conjunction with the specific contents of the technical solutions.

In the descriptions of the embodiments of the present disclosure, the descriptions of the reference terms “one embodiment/implementation”, “another embodiment/implementation” or “some embodiments/implementations”, etc. refer to that the specific features, structures, materials, or characteristics described in combination with the implementations or examples are included in at least two embodiments or implementations of the present disclosure, and the schematic expressions of the above terms do not necessarily refer to the same illustrative embodiments or implementations. Moreover, the specific features, structures, materials or characteristics described may be combined in any one or more embodiments or implementations in a suitable manner.

In addition, the technical features involved in the implementations of the present disclosure described hereinafter may be combined with each other as long as they do not conflict with each other.

With the development of an electric power system, people pay more and more attention to the research and development and use of energy-saving and environment-friendly products. Due to the advantages of three-phase balance, low no-load loss, low no-load current, low noise and low cost, a wound iron core transformer is becoming more and more popular. A foil coil often needs to be used in a wound iron core distribution transformer, and this coil is usually wound horizontally. However, a clamp for clamping an iron core needs to be mounted in this method, so that a winding device is complicated, and an operation is relatively time-consuming. Moreover, for the foil coil, a flatness of a foil is very important. For example, if a copper foil has a scratch or a damaged part, insulation between the foils is easy to be damaged during winding, thus reducing a reliability of the transformer. However, when winding the coil horizontally, it is often difficult to observe a downward face of the copper foil, so that an operator cannot fully control an operation quality. In addition, during winding, since core posts of the iron core are stressed, it is easy to cause a change of no-load loss. Moreover, after finishing winding, the iron core needs to be turned over, and during turning over, the coil is easy to shift to cause coil damage.

Therefore, the present disclosure provides a coil winding structure of a wound iron core transformer and a winding method thereof, which can simplify a winding device of the iron core, and reduce a probability of loss of the iron core caused by winding, thus optimizing a coil winding effect of the wound iron core.

The embodiments of the present disclosure are further described hereinafter with reference to the accompanying drawings.

An embodiment of the present disclosure provides a coil winding structure of a wound iron core transformer. The coil winding structure of the wound iron core transformer is applied to a wound iron core transformer, and includes: an iron core 100, a winding die 200, and a coil 300.

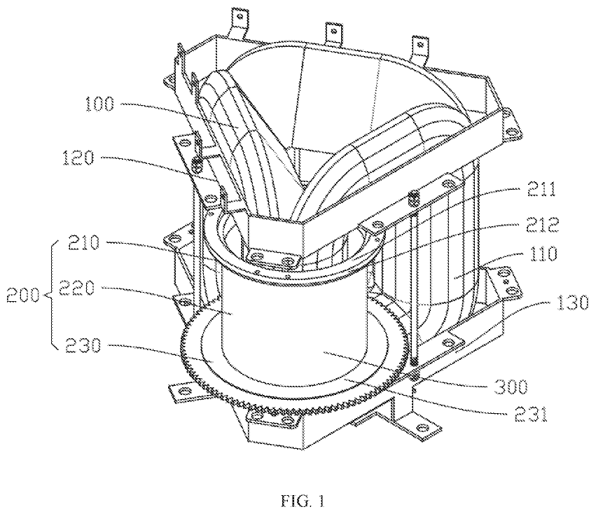

With reference to FIG. 1 to FIG. 3, specifically, the iron core 100 includes at least one core post 110. The winding die 200 is hollow, and is sleeved on the core post 110. The winding die 200 includes an upper die 210, a middle die 220 and a lower die 230. Two ends of the middle die 220 are respectively connected with the upper die 210 and the lower die 230. The upper die 210 includes a first fixing member 211 and a first rotating member 212, the lower die 230 includes a second fixing member 231 and a second rotating member 232. The first fixing member 211 is connected with the first rotating member 212, the second fixing member 231 is connected with the second rotating member 232. The first fixing member 211 and the second fixing member 231 configured used for sleeving the winding die 200 on the core posts 110. The first rotating member 212 and the second rotating member 232 are configured for driving the middle die 220 to rotate. The coil 300 is a foil coil, and the coil 300 is wound around the middle die 220.

In operation, the winding die 200 is sleeved on the core posts 110 of the wound iron core. In particular, the winding die 200 is sleeved on the core posts 110 through the first fixing member 211 of the upper die 210 and the second fixing member 231 of the lower die 230. And the coil 300 is wound around the middle die 220 under rotation of the first rotating member 212, the second rotating member 232, and the middle die 220.

It can be understood that, by means of the coil winding structure of the wound iron core transformer during winding of the coil 300 of the wound iron core transformer, the winding can be performed only by mounting the winding die 200, thus avoiding the inconvenience that a winding device in a traditional horizontal winding process needs to be mounted with a clamp of the iron core 100 for clamping the iron core 100, thus simplifying the winding device of the iron core 100. In addition, since a vertical winding method is used instead of clamping the iron core 100 during winding, an operator can conveniently observe the other face of the copper foil, so as to better control an operation quality. Moreover, in this winding method the core posts 110 are not stressed during winding of the coil 300, so that the no-load loss of the iron core 100 before and after winding is relatively stable After finishing winding of the coil 300, the iron core 100 and the coil 300 do not need to be turned over, thus reducing a probability of change in loss of the iron core 100 caused by winding, thus optimizing a winding effect of the coil 300 of the wound iron core.

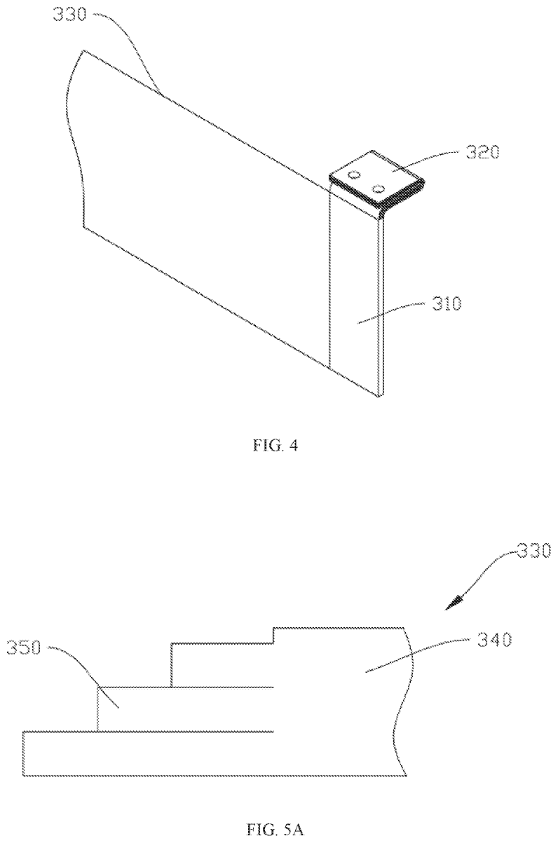

It should be noted that, with reference to FIG. 1 and FIG. 3, the wound iron core may be a three-phase stereoscopic wound iron core or a single-phase wound iron core, which is not limited in the embodiment.

With reference to FIG. 1, in some embodiments, the iron core 100 is a three-phase stereoscopic wound iron core, and three core posts 110 are provided.

With reference to FIG. 3, in some embodiments, the iron core 100 is the single-phase wound iron core, and two core posts 110 are provided.

With reference to FIG. 1, in some embodiments, the wound iron core transformer includes an upper clamp 120 and a lower clamp 130. The first fixing member 211 is connected with the upper clamp 120, and the second fixing member 231 is connected with the lower clamp 130. It can be understood that the winding can be more stable by connecting the first fixing member 211 with the upper clamp 120 and connecting the second fixing member 231 with the lower clamp 130. It should be noted that connection between the first fixing member 211 and the upper clamp 120 and connection between the second fixing member 231 and the lower clamp 130 may be a threaded connection, a snap connection, or the like, which is not limited in the embodiment.

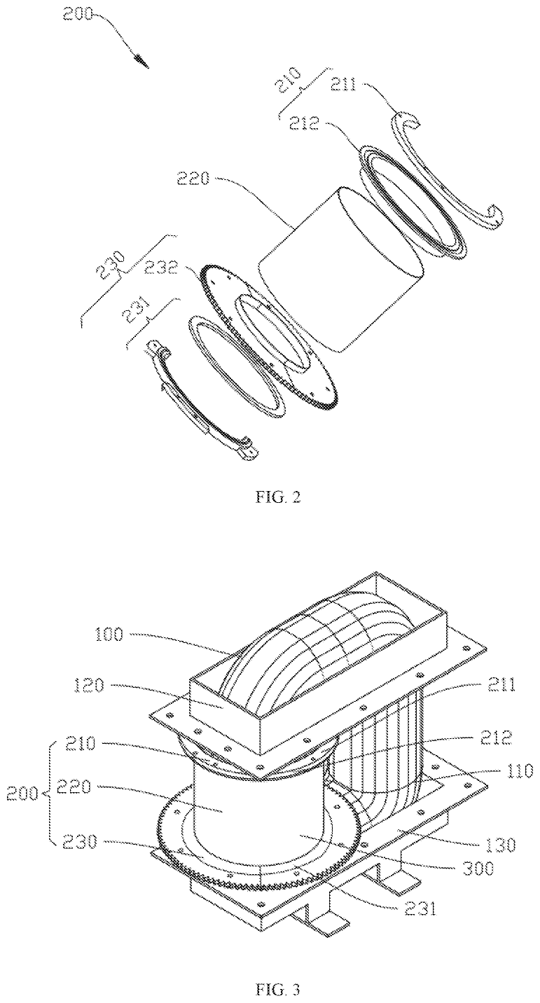

With reference to FIG. 1 and FIG. 2, the middle die 220 is of an integral cylinder structure or is of an assembled cylinder structure formed from a plurality of arc-shaped plates. It can be understood that the cylinder structure can make the winding of the coil 300 more uniform and faster.

With reference to FIG. 2, each of the first rotating member 212 and the second rotating member 232 is an assembled ring that is formed from at least two arc-shaped plates. It can be understood that, in operation, the first rotating member 212 and the second rotating member 232 are sleeved on the core posts 110 and then assembled and fixed.

In one embodiment, at least one of the upper die 210 and the lower die 230 further includes a transmission wheel, and the transmission wheel is configured for driving the middle die 220, the first rotating member 212 and the second rotating member 232 to rotate. In operation, an external device drives the transmission wheel to rotate, thus driving the middle die 220, the first rotating member 212 and the second rotating member 232 to rotate. It should be noted that only the upper die 210 or the lower die 230 may be provided with the transmission wheel, or both the upper die 210 or the lower die 230 may be provided with the transmission wheel, which is not limited in the embodiment. It should be noted that the transmission wheel may be a gear or a belt pulley, and the kind of which is not limited in the embodiment. It should be noted that any number of transmission wheels may be provided, such as one, two, or the like, which is not limited in the embodiment.

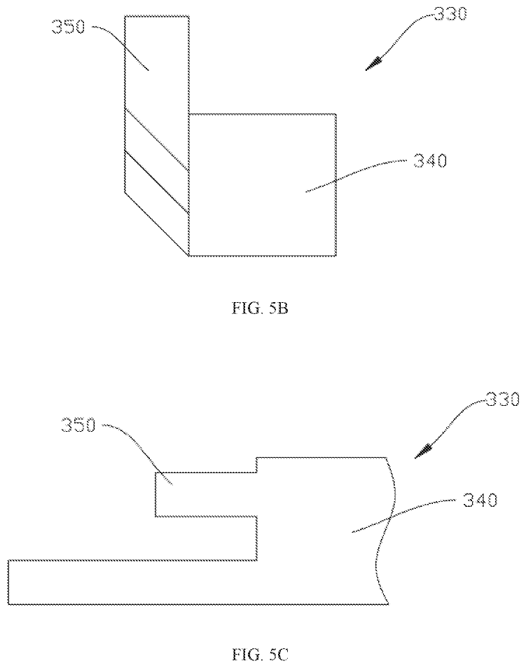

With reference to FIG. 4, in one embodiment, an outlet end of the coil 300 is provided with a copper bar 310, and one side of the copper bar 310 is provided with a flexible connection 320. Specifically, the coil 300 is led out by welding the copper bar 310, with one side of the copper bar 310 connected with the flexible connection 320. The flexible connection 320 is used as an outlet head of the coil 300.

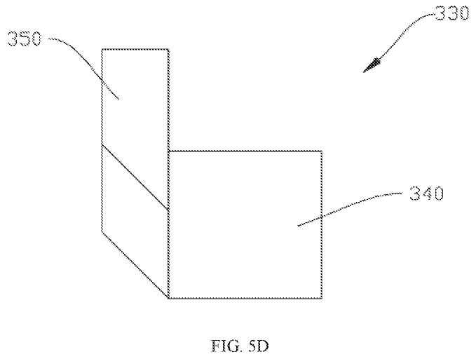

In one embodiment, the outlet end of the coil 300 includes a horizontal portion 340 and a bending portion 350, and an angle formed between the horizontal portion 340 and the bending portion 350 is 90 degrees. Specifically, as shown in FIG. 5B and FIG. 5D, the coil 300 is made of a copper foil 330, a bending leading out method is used for leading out the coil 300, in which a start end, and head and tail ends of the copper foil 330 are transversely cut into a plurality of strips, a gap may be formed between the strips, and the strips are bent upwardly at 90 degrees after cutting to form the outlet head, so that the angle formed between the horizontal portion 340 and the bending portion 350 is 90 degrees.

It should be noted that the angle formed between the horizontal portion 340 and the bending portion 350 may also be 45 degrees, 60 degrees, or the like, which is not limited in the embodiment.

In one embodiment, application of the coil winding structure of the wound iron core transformer may include the following steps.

Firstly, the upper die 210 and the lower die 230 are sleeved on the core posts 110 for assembling and fixing. Then, the middle die 220 is fixed between the upper die 210 and the lower die 230, and positions of the middle die 220, the first rotating member 212 and the second rotating member 232 are adjusted to such that the middle mold 220 is rotatable. Then, the outlet head of the coil 300 is fixed within an axial height range of the middle die 220. Finally, the transmission wheel is driven to rotate by the external device to wind the coil 300 on the middle die 220.

It can be understood that, by means of the coil winding structure of the wound iron core transformer, the winding can be performed by just mounting the winding die 200, thus avoiding the inconvenience that a winding device in a traditional horizontal winding process needs to be mounted with a clamp of the iron core 100 for clamping the iron core 100, and simplifying the winding device of the iron core 100. In addition, since a vertical winding method is used instead of clamping the iron core 100 during winding, the core posts 110 are unstressed during winding of the coil 300, so that the no-load loss of the iron core 100 before and after winding is relatively stable After finishing winding of the coil 300, the iron core 100 and the coil 300 do not need to be turned over, thus reducing a probability of loss of the iron core 100 caused by winding, and optimizing a winding effect of the coil 300 of the wound iron core.

In one embodiment, the wound iron core transformer includes an upper clamp 120 and a lower clamp 130. Before the upper die 210 and the lower die 230 are sleeved on the core posts 110 for assembling and fixing, the first fixing member 211 is connected with the upper clamp 120, and the second fixing member 231 is connected with the lower clamp 130 to sleeve the winding die 200 on the core posts 110.

It can be understood that the winding can be more stable by connecting the first fixing member 211 with the upper clamp 120 and connecting the second fixing member 231 with the lower clamp 130. It should be noted that connection between the first fixing member 211 and the upper clamp 120 and connection between the second fixing member 231 and the lower clamp 130 may be a threaded connection, a snap connection, or the like, which is not limited in the embodiment.

In some embodiments, with reference to FIG. 5A to FIG. 5B, the coil 300 is made of a copper foil 330, the coil 300 may be led out in such a way that, an outlet head of the copper foil 330 is cut along a winding direction, and the outlet head of the copper foil 330 is cut into a plurality of strips. The strips are bent upwardly at 90 degrees to be led out, and fixed within an axial height of the middle die 220.

In some embodiments, with reference to FIG. 5C to FIG. 5D, the coil 300 is made of a copper foil 330, a bending leading out method of the coil 300 may be performed in which an outlet head of the copper foil 330 is cut along a winding direction, and the outlet head of the copper foil 330 is cut into several strips. A gap is formed between the strips, and the strips are bent upwardly by 90 degrees to be led out, and fixed within an axial height of the middle die 220.

The embodiments of the present disclosure are described in detail with reference to the accompanying drawings above, but the present disclosure is not limited to the above embodiments, and various changes may also be made within the knowledge scope of those of ordinary skills in the art without departing from the purpose of the present disclosure.

1. A coil winding structure of a wound iron core transformer applied to a wound iron core transformer, wherein the coil winding structure of the wound iron core transformer comprises:
an iron core, wherein the iron core comprises at least one core post;
a winding die, wherein the winding die is of a hollow structure, is sleeved around the core post, and comprises an upper die, a middle die and a lower die, one end of the middle die is connected with the upper die and the other end of the middle die is connected with the lower die, the upper die comprises a first fixing member and a first rotating member, the lower die comprises a second fixing member and a second rotating member, the first fixing member is connected with the first rotating member, the second fixing member is connected with the second rotating member, the first fixing member and the second fixing member are configured for sleeving the winding die around the core post, and both the first rotating member and the second rotating member are configured for driving the middle die to rotate; and
a coil, wherein the coil is a foil coil, and the coil is wound around the middle die.

2. The coil winding structure of the wound iron core transformer according to claim 1, wherein the iron core is a three-phase stereoscopic wound iron core, and three core posts are provided.

3. The coil winding structure of the wound iron core transformer according to claim 1, wherein the iron core is a single-phase wound iron core, and two core posts are provided.

4. The coil winding structure of the wound iron core transformer according to claim 1, wherein the wound iron core transformer comprises an upper clamp and a lower clamp, the first fixing member is connected with the upper clamp, and the second fixing member is connected with the lower clamp.

5. The coil winding structure of the wound iron core transformer according to claim 1, wherein the middle die is of an integrated cylinder structure, or an assembled cylinder structure formed from a plurality of arc-shaped plates.

6. The coil winding structure of the wound iron core transformer according to claim 1, wherein each of the first rotating member and the second rotating member is an assembled ring that is form from at least two arc-shaped plates.

7. The coil winding structure of the wound iron core transformer according to claim 1, wherein at least one of the upper die and the lower die further comprises a transmission wheel, and the transmission wheel is configured for driving each of the middle die, the first rotating member and the second rotating member to rotate.

8. The coil winding structure of the wound iron core transformer according to claim 1, wherein an outlet end of the coil is provided with a copper bar, and one side of the copper bar is provided with a flexible connection.

9. The coil winding structure of the wound iron core transformer according to claim 1, wherein an outlet end of the coil comprises a horizontal portion and a bending portion, and an angle formed between the horizontal portion and the bending portion is 90 degrees.
